(19) United States
(12) Patent Application Publication
(10) Pub. No.: US 2013/0269658 A1
(43) Pub. Date: Oct. 17, 2013

(54) VARIABLE STROKE ASSEMBLY

(71) Applicant: Raymond Sydney O'Donnell, Greenwith (AU)

(72) Inventor: Raymond Sydney O'Donnell, Greenwith (AU)

(21) Appl. No.: 13/883,880

(22) PCT Filed: Sep. 26, 2011
(86) PCT No.: PCT/AU2011/001238

§ 371 Date: May 7, 2013

(30) Foreign Application Priority Data
Jan. 12, 2011 (AU) 2011900079

(51) Int. Cl. F02D 15/00

(52) U.S. Cl. CPC F02D 15/00
USPC 123/48 R

(57) ABSTRACT

There is proposed a variable stroke assembly having a primary crank, the primary crank having a primary axis of rotation; a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation; a secondary crank having a third axis of rotation, wherein the secondary crank cooperatively engages the spur gear such that the third axis of rotation is further offset from the primary and secondary axis of rotation; a connecting rod, with a first and second end, the first end of connecting rod is pivotally connected to the secondary crank, wherein operation the connecting rod travels in a substantially linear motion that translates into rotational motion of the secondary crank, spur gear and primary crank.

### FIELD OF THE INVENTION

The present invention relates to internal combustion engines and motors. In particular, the present invention relates to a variable stroke assembly capable of producing efficient and effective variable stroke length, such that when applied to an internal combustion engine or similar application, the efficiency and performance of the engine is enhanced.

### DESCRIPTION OF THE PRIOR ART

In conventional internal combustion engine assemblies, pistons often follow a predetermined cycle of strokes comprised of an intake stroke, a compression stroke, expansion stroke and an exhaust stroke. Generally, power is recovered from the combustion process via these four separate movements, or strokes, of the piston.

The reciprocating motion of the pistons is then transferred to rotary motion of a crankshaft via a connecting rod. For example, a two-stroke engine will produce power for every revolution of the crankshaft, whilst a four-stroke cycle engine produces power once every two revolutions of the crankshaft.

Variations in the stroke length travelled by the piston during operation can affect the efficiency and performance of the engine. Many of these existing assemblies employ a symmetrical configuration, wherein the centre line of the piston and cylinder pass through the centre of rotation of the crankshaft. The symmetrical configuration does not allow for effective variation in the stroke length of the piston.

Further, in conventional assemblies the connecting rod, which joins the piston and the gear assembly, often adopts a slightly canted position during the cycle of the piston. This canting results from the linear motion of the piston at one end of the connecting rod and the rotational motion of the gear assembly at the other. Consequently, the canting of the connecting rod can reduce the force transferred from the piston to gear assembly, thereby effecting the performance of the engine.

Further, the canting of the connecting rod also generates lateral force on piston as it travels through the cylinder. Consequently, friction between the piston and the sidewall of the cylinder is increased.

The friction generated over time increases the wear and tear on both the piston and cylinder, compromising the function of these components and the effective lifespan of the engine assembly.

As such, assemblies that are capable of efficient and effective varied input and/or output are highly desired.

Different methods and assemblies have been devised in order to achieve variable stroke length.

For example, mechanical means of achieving variable stroke length have often involved increasing the radial displacement of the pistons and cylinders. However, this often requires an increase in the diameter and number of pistons and/or cylinders. Of course there are practical limitations on the number of pistons and cylinders that can be employed.

Another means of achieving variable stroke length has involved the use of a pair of pistons within a cylinder and varying the distance between the two pistons. As such, when the pistons move toward one another, the stroke length will be increased. Alternatively, when the pistons move away from one another, stroke length is decreased.

The majority of these methods and assemblies have been based on an engine having the capability of operating through a range of different strokes. However, one of the main disadvantages of existing variable stroke engines and assemblies is that they are often cumbersome and mechanically complex.

Consequently, the increased mechanical complexity of these assemblies often limits their applicability to a specific engine and prevents them from being applied and used in other applications.

### OBJECT OF THE INVENTION

It is an object of the present invention to provide an effective and efficient variable stroke assembly with widespread application and use.

Unlike existing variable stroke assemblies, the present invention is advantageous in that it can suitable for use in conventional internal combustion engines and other applications where variable stroke may be required and applicable. For example, mechanical punch presses similarly employ a crankshaft similar to that found in an engine. The unique configuration of the assembly does not involve or require a complex mechanical assembly, which enables it to be suitably adapted to a wide range of applications.

Further, the configuration of the assembly also achieves effective dynamic stroke variation during operation. The obvious advantage of effective stroke variation particularly when the assembly is used in an internal combustion engine, being that it can increase and enhance the performance and efficiency of the engine.

The assembly does not utilize a symmetrical configuration like conventional assemblies. The assembly utilizes an array of hypocycloid gears with a connecting rod, wherein the axis of each gear and the connecting rod is offset from one another. Effectively, there are at least three separate axes of rotation, which enable effective stroke variation to be achieved.

Variation in stroke length can be achieved by convenient adjustment in the configuration of the assembly. Advantageously, adjustments can be made without the need to dismantle the assembly. As such, adjustments to the assembly can be made conveniently and quickly as desired.

Advantageously, adjustments to the configuration of the assembly can be performed dynamically while the primary shaft is rotating. Conventional assemblies often only allow for adjustments if the assembly is static. This can be inconvenient and time consuming, particularly if regular adjustments are required to achieve the desired variation in stroke length.

Additionally, the configuration of the assembly eliminates canting of the connecting rod at full stroke and generation of lateral forces on the piston during operation. Advantageously, this minimises undue wear and tear on both the piston and cylinder. Reduction in the wear of components within the assembly minimises the need for frequent maintenance and replacement of these components, thereby effectively prolonging the life of the assembly.

Further, the design of the variable stroke assembly enables it to be compatible and utilized in a wide range of applications beyond that of internal combustion engines and motors. Effectively, the assembly can be utilized in various applications that require variable stroke including liquid pumps, gas compressors, steam power assemblies, wave power assemblies, stamping presses, clamping assemblies and refrigeration assemblies.

Other objects and advantages of the present invention will become apparent from the following description, taken in connection with the accompanying drawings, wherein by way of illustration and example, an embodiment of the present invention is disclosed.

### SUMMARY OF THE INVENTION

In one form of the invention, although this should not be seen as limiting in any way, there is proposed a variable stroke assembly having:
a primary crank, the primary crank having a primary axis of rotation;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation;
a secondary crank having a third axis of rotation, wherein the secondary crank cooperatively engages the spur gear such that the third axis of rotation is further offset from the primary and secondary axis of rotation;
a connecting rod, with a first and second end, the first end of connecting rod is pivotally connected to the secondary crank,
   wherein operation the connecting rod travels in a substantially linear motion that translates into rotational motion of the secondary crank, spur gear and primary crank.

Preferably, the second end of the connecting rod is pivotally connected to a piston.

Preferably, the variable stroke assembly is housed within a case, the case having a gear assembly mounted thereon.

Preferably, the case is rotatably housed within an outer enclosure, such that rotation of the gear assembly rotates the case within the enclosure and rotates the axis of translation of the variable stroke assembly, thereby varying the stroke length of the piston and connecting rod.

Preferably, the variable stroke assembly can be adjusted dynamically to the desired angle of rotation while the primary crank is rotating.

Preferably, the variable stroke assembly assumes a top dead centre position or zero degrees when the position of connecting rod, secondary crank and spur gear coincides with the centreline of a piston and cylinder.

Alternatively, the variable stroke assembly may include a locking bolt, which locks the case into a fixed position within the outer enclosure, for fixed stroke applications.

Preferably, the primary, secondary and third axes of rotation are parallel.

Preferably, the ratio of the internal gear and spur gear of the hypocycloid gear set is 2:1.

Preferably, the offset distance the primary axis of rotation of the primary crank from the secondary axis of rotation of the spur gear is at least one half of the diameter of the spur gear.

Preferably, the offset distance of the third axis of rotation of the secondary crank from the secondary axis of rotation of the spur gear is at least one half of the diameter of the spur gear.

Alternatively, a coupling gear and flange may be attached to the primary crank to enable coupling of one or more variable stroke assemblies.

In a further form of the invention, there is an engine utilizing a variable stroke assembly including:
an engine piston;
a variable stroke assembly including a primary crank, the primary crank having a primary axis of rotation;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation;
a secondary crank having a third axis of rotation, wherein the secondary crank cooperatively engages the spur gear such that the third axis of rotation is further offset from the primary and secondary axis of rotation;
a connecting rod, with a first and second end, the first end of connecting rod is pivotally connected to the secondary crank and the second end pivotally connected to the engine piston;
   wherein operation the engine piston and connecting rod travels in a substantially linear motion that translates into rotational motion of the secondary crank, spur gear and primary crank.

### BRIEF DESCRIPTION OF THE DRAWINGS

For a better understanding of the present invention, it will now be described with respect to the preferred embodiment which shall be described herein with reference to the accompanying drawings wherein:

FIG. 1 is a partially exploded perspective view of an embodiment of the variable stroke assembly;

FIG. 2 is a fully exploded side view of the embodiment of the variable stroke assembly illustrated in FIG. 1;

FIG. 3 is a partially exploded side view of a further embodiment of the variable stroke assembly;

FIG. 4 is a fully exploded side view of the further embodiment of the variable stroke assembly as illustrated in FIG. 3;

FIGS. 5a-5f is an end view of the variable stroke assembly connected to a piston, showing the various positions of the hypocycloid gear set of the assembly through a single stroke cycle from 0° through to 360° revolution and the standard stroke length of the piston through the stroke cycle;

FIGS. 5g-5l is an end view of the variable stroke assembly connected to a piston, showing the various positions of the hypocycloid gear set of the assembly through a single stroke cycle from 0° through to 360° revolution, wherein the hypocycloid gear set has been rotated 60° and the stroke length of the piston through the cycle is decreased.

FIGS. 6a-6b is an end view of the variable stroke assembly showing rotation of the assembly and the position of the spur gear, secondary crank and connecting rod as it travels through a full stroke cycle.

FIGS. 7a-7g are perspective end views of the variable stroke assembly showing the various positions of the spur gear, secondary crank and connecting rod of the assembly and the axes of rotation throughout a stroke cycle.

### DETAILED DESCRIPTION OF THE INVENTION

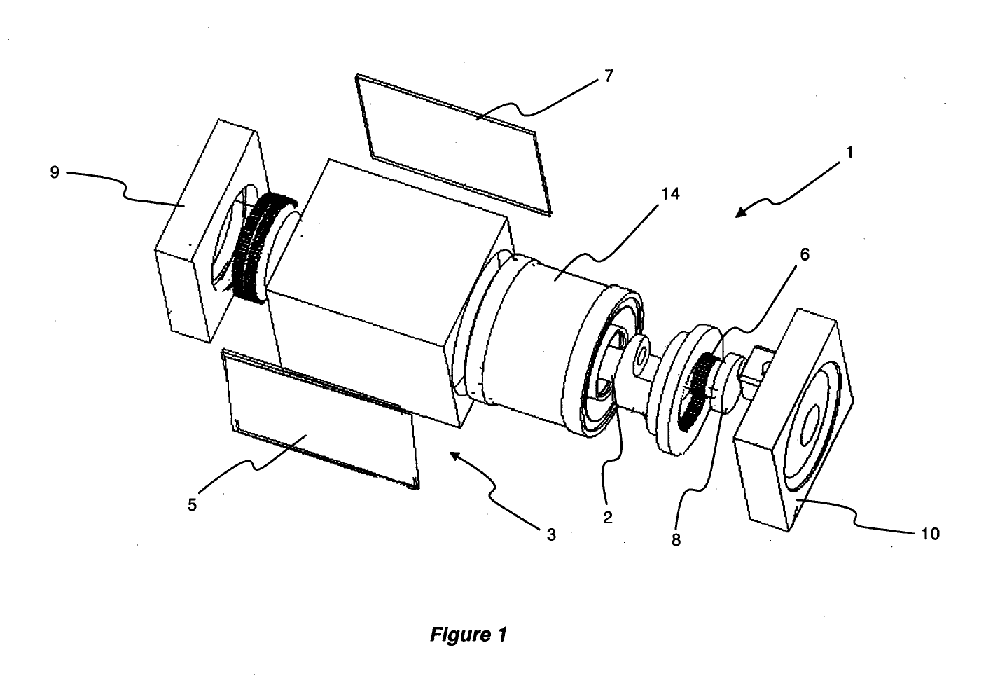

Referring to FIG. 1, where there is illustrated a perspective view of an embodiment of the variable stroke assembly (1) in a partially exploded view, comprising an outer enclosure (3). The outer enclosure (3) having at least two opposing sidewalls (5) and (7) and at least two opposing end walls (9) and (10). The outer enclosure (3) houses the internal components of the variable stroke assembly (1).

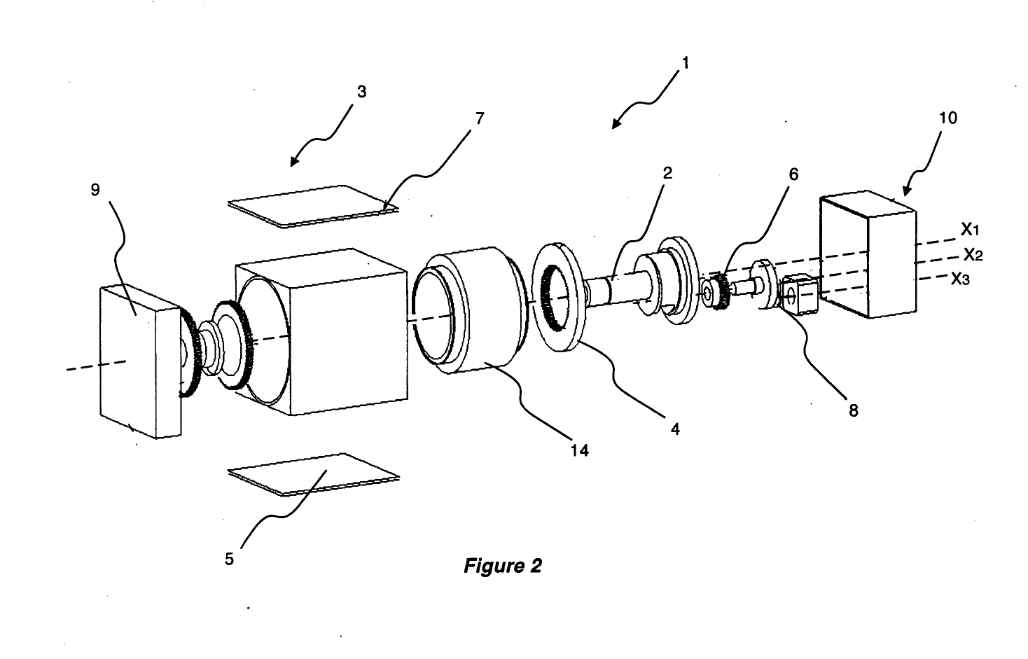

The unique configuration of the variable stroke assembly (1) comprises of a primary crank (2), wherein the primary crank (2) has a primary axis of rotation, as indicated by X₁. The primary axis of rotation X₁ is illustrated in FIG. 2 by the dotted line extending through to the end wall (10) of the outer enclosure (3).

In this particular embodiment, the primary crank (2) is a single shafted crank. FIG. 2 illustrates a fully exploded side view of the embodiment of the variable stroke assembly (1) and it can be seen that the primary crank (2) is a single shafted crank.

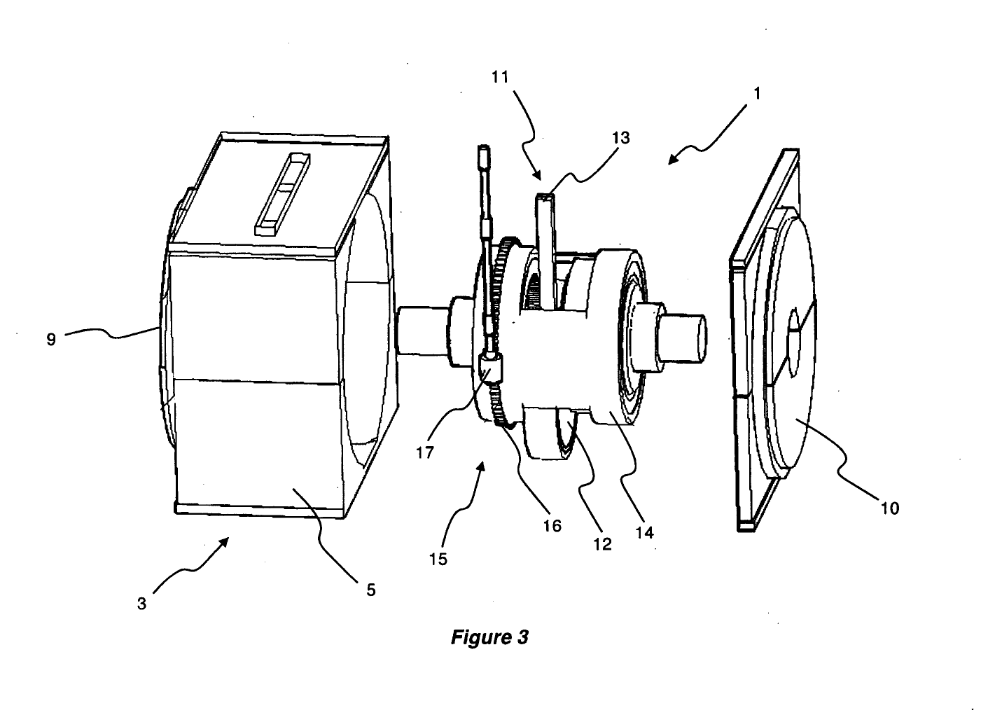

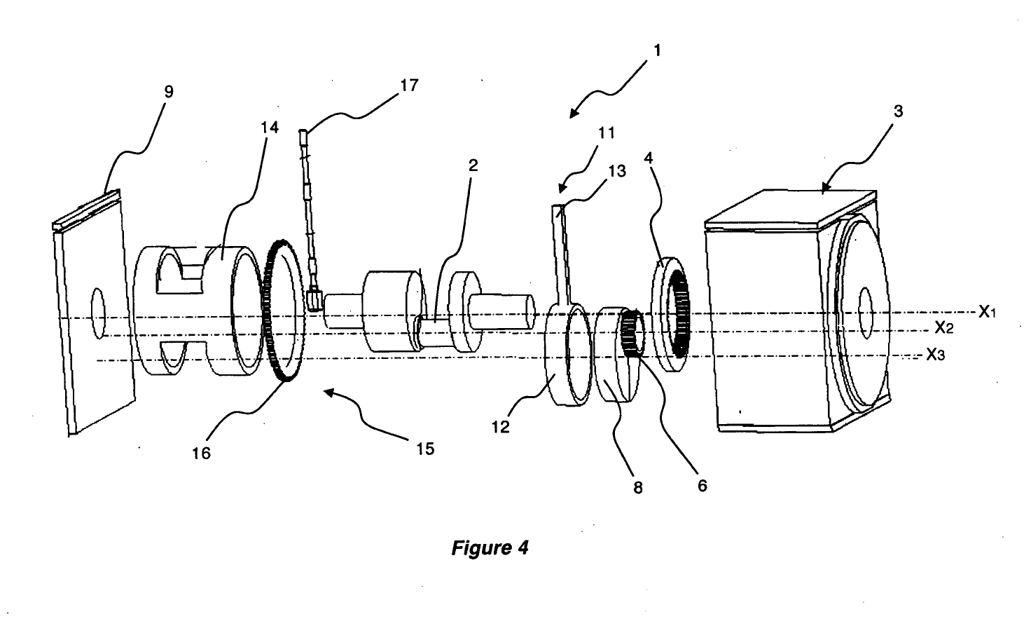

FIGS. 3 and 4 illustrate a further embodiment of the variable stroke assembly (1) wherein the primary crank (2) of the assembly is a double-shafted crank. Although the primary crank (2) in this further embodiment comprises of a double-shafted crank, the primary crank (2) still rotates about the primary axis of rotation being X₁. FIG. 3 being the fully exploded side view of the further embodiment illustrates the axis of rotation X₁ of the primary crank (2).

The primary crank (2) cooperatively engages and rotates within an internal gear (4). The internal gear (4) having an axis of rotation that coincides with the primary axis of rotation X₁ of the primary crank (2).

A spur gear (6) is pivotally mounted and supported on the primary crank (2). The spur gear (6) having a secondary axis of rotation as indicated by X₂. The spur gear (6) is mounted on the primary crank (2) such that the secondary axis of rotation X₂ is offset from the primary axis of rotation X₁ of the primary crank (2) and internal gear (4).

The arrangement of internal gear (4) and the spur gear (6) effectively form a hypocycloidal gear set of the variable stroke assembly (1).

A secondary crank (8) cooperatively engages the spur gear (6). The secondary crank having a third axis of rotation, as indicated by X₃. The secondary crank (8) engages the spur gear (6) such that the third axis of rotation X₃ is offset from the secondary axis of rotation X₂ of the spur gear (6). The third axis of rotation X₃ is also further offset from the primary axis of rotation X₁ of the primary crank (2).

The distance by which the secondary axis of rotation X₂ of the spur gear (6) is offset from the primary axis of rotation X₁ of the primary crank (2) and internal gear (4) is equal to half the pitch diameter (PD) of the internal gear (4). That is, the pitch diameter (PD) of the internal gear (4) is the effective internal diameter of the internal gear (4).

As such, the gear ratio of the internal gear (4) and the spur gear (6) is effectively 2:1 with the spur gear (6) rotating inside the internal gear (4).

Similarly, the secondary crank (8) is mounted on the spur gear (6) such that the centre of the secondary crank (8) cooperatively engages the pitch diameter of the spur gear (6). As such, the offset distance of the third axis of rotation X₃ of the secondary crank (8) to the secondary axis of rotation X₂ of the spur gear (6) is half the pitch diameter of the spur gear (6).

The three axes of rotation X₁, X₂ and X₃ whilst offset from one another, remain substantially parallel.

The variable stroke assembly (1) further includes a connecting rod (11). The connecting rod (11) having a first (12) and second end (13). The first end (12) is pivotally mounted to the secondary crank (8) and the second end (13) can be pivotally connected to a piston (18).

The variable stroke assembly (1) is housed within a case (14). The case (14) houses the primary crank (2), internal gear (4), spur gear (6) and secondary crank (8) such that these components are effectively housed as a singular unit.

Mounted on the case (14) is a worm gear assembly (15). The worm gear assembly (15) comprising of a worm gear (16) which is sized such that it can be mounted around the edge of the case (14) and a worm drive (17), which drives the rotation of the worm gear (16). The worm gear assembly (15) with respect to the case (14) can be seen in greater detail in FIG. 4.

The arrangement of the worm gear assembly (15) with respect to the case (14) is such that the worm gear (16) cooperatively engages the case (14). Effectively, when the worm gear (16) is rotated via the worm drive (17), it enables rotation of the case (14) and effectively the rotation of the primary crank (2), internal gear (4), spur gear (6) and secondary crank (8).

The rotation of the case (14) effectively rotates the various axes of rotation X₁, X₂ and X₃ of the components. It is the rotation in the axes that facilitates effective variation in stroke length of the connecting rod, and piston attached thereto. In rotating the various axes to the desired degree, the stroke length may be elongated or shortened, as required.

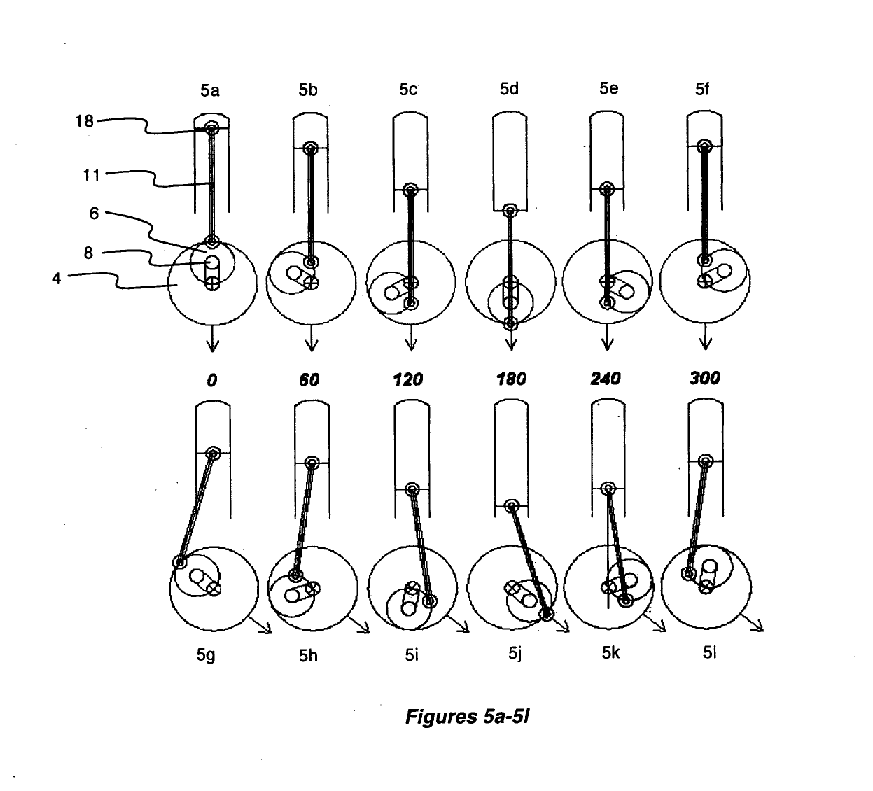

FIGS. 5a to 5f illustrate the position of the spur gear (6) and secondary crank (8) throughout a standard full stroke cycle. For example, in FIG. 5a, the spur gear (6) and secondary crank (8) and connecting rod (11) are effectively in the top dead centre position wherein the centreline of the connecting rod (11) coincides with the centreline of the piston (18).

Throughout the full stroke cycle the corresponding position and travel of the piston (18) is illustrated. The maximum stroke length is illustrated by FIGS. 5a to 5f.

In FIGS. 5g to 5l, the spur gear (6) and secondary crank (8) has been rotated 60° from the top dead centre position. As such, this rotation has effectively shifted the axes of rotation of the spur gear (6) and secondary crank (8), being X₂ and X₃ respectively. Subsequently, path travelled by the connecting rod (11) during the stroke cycle now changes and the stroke length is decreased compared to the stroke length at 0° rotation during the standard full stroke cycle of FIGS. 5a to 5f.

The assembly (1) can be rotated accordingly to the desired degree of rotation to affect either elongated or shortened stroke length, depending on the conditions required.

In tilting the axes of rotation of the assembly (1) it conveniently increases or decreases the distance travelled the connecting rod (11) without the need to incorporate mechanically complex configurations.

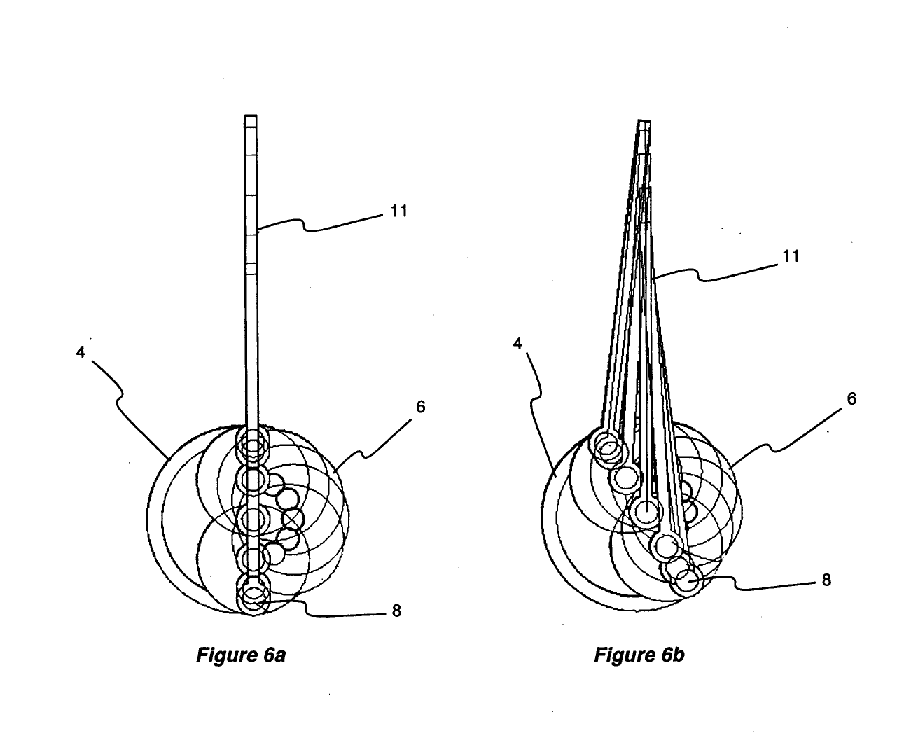

FIGS. 6a and 6b, further illustrate the effect of rotation of the case (14) and the axes of rotation of the assembly (1). FIG. 6a illustrates the rotational path of travel of the spur gear (6) and secondary crank (8) during the standard full stroke cycle as illustrated in FIGS. 5a to 5f, wherein the connecting rod (11) moves in a purely linear motion. It can be seen that the connecting rod (11) does not waiver from its position wherein it strictly travels up or down.

By contrast, in FIG. 6b when the assembly (1) is rotated the connecting rod (11) cants outwardly from its centreline and the rotational path travelled by the spur gear (6) and secondary crank (8) differs significantly. FIG. 6b indicates the movement of the assembly (1) through the cycle as illustrated in FIGS. 5j-5l above.

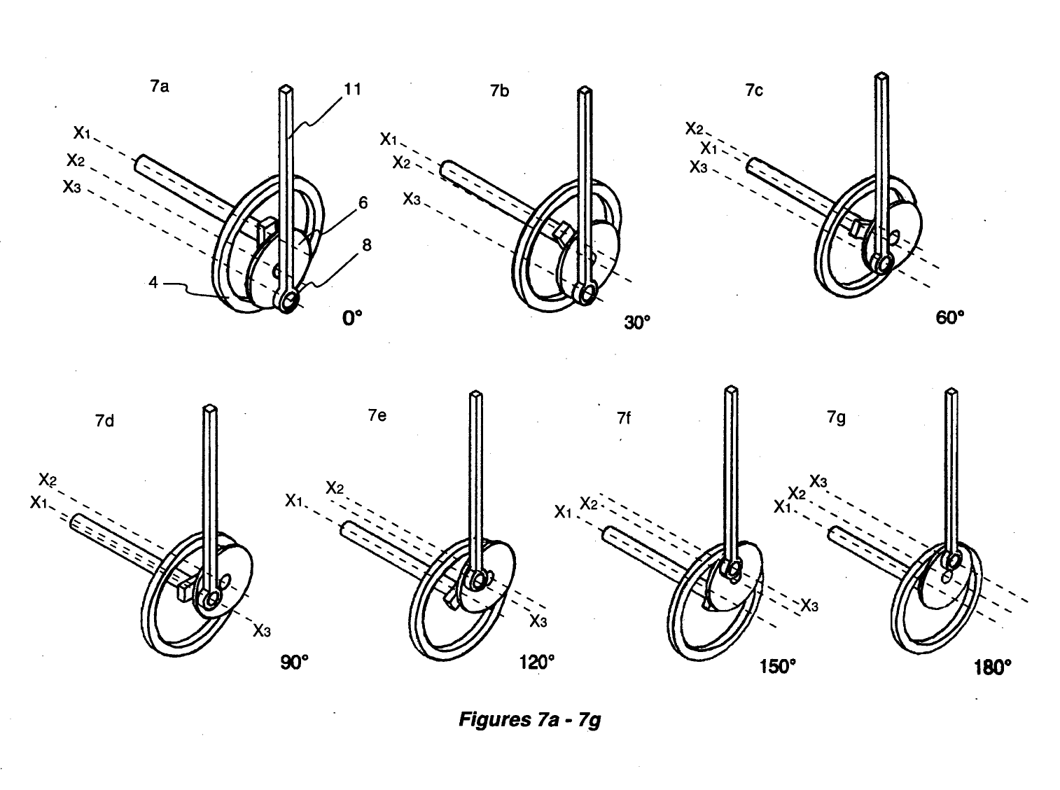

FIGS. 7a to 7g illustrate further perspective views of the of the variable stroke assembly (1) from the top centre position or 0°, at 30° increments throughout a stroke cycle. When the gears are set at the top centre position or 0° position, the stroke length travelled by the connecting rod (11) is at a maximum and the path and motion of travel is linear.

Advantageously, the assembly (1) can be rotated to the desired degree of rotation conveniently via the worm gear assembly (15) without the need to dismantle the outer enclosure (3) or case (14). Further, rotation of the case (14) can be performed dynamically whilst the primary crank (2) is in motion.

As such, when the assembly is used in conjunction with an engine, it enables the stroke length to be varied conveniently during operation.

Alternatively, the variable stroke assembly (1) may include a locking mechanism, which enables the case (14) to be locked at a fixed angle of rotation. This is particularly useful in applications that require fixed stroke rather than variable stroke.

In an alternative embodiment, the primary crank (2) may have a coupling gear and flange attached thereto. This enables multiple variable stroke assemblies to be coupled to one another as desired.

The unique configuration of the assembly (1) enables it to be applied to a wide variety of applications such as conventional internal combustion engines, low friction internal combustion engines, wind generators, mechanical punch presses or similar applications where variable reciprocal motion is required.

Although the invention has been herein shown and described in what is conceived to be the most practical and preferred embodiment, it is recognised that departures can be made within the scope of the invention, which is not to be limited to the details described herein but it is to be accorded the full scope of the appended claims so as to embrace any and all equivalent devices and apparatus.

1. A variable stroke assembly having:
a primary crank, the primary crank having a primary axis of rotation;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation;
a secondary crank having a third axis of rotation, wherein the secondary crank cooperatively engages the spur gear such that the third axis of rotation is further offset from the primary and secondary axes of rotation; and
a connecting rod, with a first end and a second end, the first end of connecting rod is pivotally connected to the secondary crank, wherein operation, the connecting rod travels in a substantially linear motion, which translates into rotational motion of the secondary crank, spur gear and primary crank of the assembly,
wherein the variable stroke assembly being housed within a case, wherein the case includes a gear assembly mounted thereon, the case is rotatably housed within an outer enclosure, such that rotation of the gear assembly dynamically during operation, rotates the case within the enclosure and rotates the axes of translation of the variable stroke assembly, thereby varying the stroke length of the connecting rod.

2. The variable stroke assembly as in claim 1, wherein the second end of the connecting rod is pivotally connected to a piston.

3. The variable stroke assembly as in claim 1, wherein the variable stroke assembly comprises a locking bolt, which locks the case into a fixed position within the outer enclosure, for fixed stroke applications.

4. The variable stroke assembly as in claim 1, wherein the variable stroke assembly is configured to be adjusted dynamically to the desired angle of rotation while the primary crank is rotating.

5. The variable stroke assembly as in claim 1, wherein the variable stroke assembly assumes a top dead centre position when the position of connecting rod, secondary crank and spur gear coincides with the centreline of a piston and cylinder.

6. The variable stroke assembly as in claim 1, wherein the primary, secondary and third axes of rotation are parallel.

7. The variable stroke assembly as in claim 1, wherein the internal gear and spur gear of the hypocycloid gear are in a ratio of 2.1.

8. The variable stroke assembly as in claim 6, wherein the offset distance the primary axis of rotation of the primary crank from the secondary axis of rotation of the spur gear is at least one half of the diameter of the spur gear.

9. The variable stroke assembly as in claim 8, wherein the offset distance of the third axis of rotation of the secondary crank from the secondary axis of rotation of the spur gear is at least one half of the diameter of the spur gear.

10. The variable stroke assembly as in claim 1, wherein a coupling gear and a flange may be attached to the primary crank to enable coupling of one or more variable stroke assemblies.

11. An engine utilizing a variable stroke assembly as in claim 1, further comprising:
an engine piston;
a variable stroke assembly including a primary crank, the primary crank having a primary axis of rotation;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation;
a secondary crank having a third axis of rotation, wherein the secondary crank cooperatively engages the spur gear such that the third axis of rotation is further offset from the primary and secondary axis of rotation; and
a connecting rod comprising a first end and a second end, the first end pivotally connected to the secondary crank and the second end pivotally connected to the engine piston;
wherein operation the engine piston and connecting rod travels in a substantially linear motion that translates into rotational motion of the secondary crank, spur gear and primary crank; and
wherein the variable stroke assembly is housed within a case, wherein the case includes a gear assembly mounted thereon, the case is rotatably housed within an outer enclosure, such that rotation of the gear assembly rotates the case within the enclosure and rotates the axis of translation of the variable stroke assembly, thereby varying the stroke length of the piston and connecting rod.

12. The variable stroke assembly as in claim 2, wherein the variable stroke assembly further comprises a locking bolt, which locks the case into a fixed position within the outer enclosure, for fixed stroke applications.

13. The variable stroke assembly as in claim 2, wherein the variable stroke assembly can be adjusted dynamically to the desired angle of rotation while the primary crank is rotating.

14. The variable stroke assembly as in claim 3, wherein the variable stroke assembly can be adjusted dynamically to the desired angle of rotation while the primary crank is rotating.

15. The variable stroke assembly as in claim 2, wherein the variable stroke assembly assumes a top dead centre position or zero degrees when the position of connecting rod, secondary crank and spur gear coincides with the centreline of a piston and cylinder.

16. The variable stroke assembly as in claim 3, wherein the variable stroke assembly assumes a top dead centre position or zero degrees when the position of connecting rod, secondary crank and spur gear coincides with the centreline of a piston and cylinder.

17. The variable stroke assembly as in claim 4, wherein the variable stroke assembly assumes a top dead centre position or zero degrees when the position of connecting rod, secondary crank and spur gear coincides with the centreline of a piston and cylinder.

18. The variable stroke assembly as in claim 7, wherein the offset distance the primary axis of rotation of the primary crank from the secondary axis of rotation of the spur gear is at least one half of the diameter of the spur gear.

19. A variable stroke assembly having:
a primary crank, the primary crank having a primary axis of rotation;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation;
a secondary crank having a third axis of rotation, wherein the secondary crank cooperatively engages the spur gear such that the third axis of rotation is further offset from the primary and secondary axes of rotation, and wherein the primary, secondary and third axes of rotation are parallel; and
a connecting rod, with a first end and a second end, the first end of connecting rod is pivotally connected to the secondary crank, wherein operation, the connecting rod travels in a substantially linear motion, which translates into rotational motion of the secondary crank, spur gear and primary crank of the assembly, wherein the second end of the connecting rod is pivotally connected to a piston;
wherein the variable stroke assembly being housed within a case, wherein the case includes a gear assembly mounted thereon, the case is rotatably housed within an outer enclosure, such that rotation of the gear assembly dynamically during operation, rotates the case within the enclosure and rotates the axes of translation of the variable stroke assembly, thereby varying the stroke length of the connecting rod.

20. A variable stroke assembly having:
a primary crank, the primary crank having a primary axis of rotation, wherein a coupling gear and a flange may be attached to the primary crank to enable coupling of one or more variable stroke assemblies;
a hypocycloid gear set having at least one internal gear and at least one spur gear, the internal gear having an axis of rotation that coincides with the primary axis of rotation of the primary crank and the spur gear having a secondary axis of rotation, wherein the primary crank cooperatively engages and rotates within the internal gear about the primary axis of rotation, the spur gear pivotally mounted on the primary crank such that the secondary axis of rotation is offset from the primary axis of rotation, wherein the internal gear and spur gear of the hypocycloid gear are in a ratio of 2:1;
a secondary crank having a third axis of rotation, wherein the secondary crank cooperatively engages the spur gear such that the third axis of rotation is further offset from the primary and secondary axes of rotation; and
a connecting rod, with a first end and a second end, the first end of connecting rod is pivotally connected to the secondary crank, wherein operation, the connecting rod travels in a substantially linear motion, which translates into rotational motion of the secondary crank, spur gear and primary crank of the assembly,
wherein the variable stroke assembly being housed within a case, wherein the case includes a gear assembly mounted thereon, the case is rotatably housed within an outer enclosure, such that rotation of the gear assembly dynamically during operation, rotates the case within the enclosure and rotates the axes of translation of the variable stroke assembly, thereby varying the stroke length of the connecting rod.
